(19) United States
(12) Patent Application Publication
(10) Pub. No.: US 2026/0220848 A1
(43) Pub. Date: Jul. 30, 2026

(54) VIRTUAL FITTING METHOD AND APPARATUS, AND STORAGE MEDIUM

(71) Applicant: Beijing Zitiao Network Technology Co., Ltd., Beijing (CN)

(72) Inventor: Xingxin ZHU, Beijing (CN)

(21) Appl. No.: 19/142,129

(22) PCT Filed: Dec. 12, 2023
(86) PCT No.: PCT/CN2023/138095

§ 371 Date: Jun. 20, 2025

(30) Foreign Application Priority Data
Dec. 20, 2022 (CN) 202211643676.3

(51) Int. Cl. G06T 11/60; G06T 7/11; G06T 7/73

(52) U.S. Cl. CPC G06T 11/60; G06T 7/11; G06T 7/73; G06T 2200/24; G06T 2207/20081; G06T 2207/20221; G06T 2207/30196; G06T 2210/16

(57) ABSTRACT

The embodiments of the present disclosure disclose a virtual fitting method and apparatus, an electronic device, and a storage medium. The virtual fitting method includes: obtaining a target object image with which a try-on operation associates, in response to the try-on operation being received by a content browsing interface, where the content browsing interface is configured to display a media content stream including at least one media content; generating a target object try-on image according to a preset user image, preprocessed pose information of the user image, and the target object image; and displaying a try-on interface, and presenting the target object try-on image on the try-on interface.

### CROSS-REFERENCE TO RELATED APPLICATIONS

This application is a national phase application of International Patent Application No. PCT/CN2023/138095, filed on Dec. 12, 2023, which claims the priority to and benefits of the Chinese Patent Application No. 202211643676.3, which was filed on Dec. 20, 2022. All the aforementioned patent applications are hereby incorporated by reference in their entireties.

### TECHNICAL FIELD

Embodiments of the disclosure relate to a virtual fitting method and apparatus, an electronic device, and a storage medium.

### BACKGROUND

Currently, in the virtual fitting field, there is a need for quick fitting in some scenarios.

### SUMMARY

Embodiments of the disclosure provide a virtual fitting method and apparatus, an electronic device, and a storage medium.

According to a first aspect, an embodiment of the disclosure provides a virtual fitting method. The method includes:
obtaining a target object image with which a try-on operation associates, in response to the try-on operation being received by a content browsing interface, where the content browsing interface is configured to display a media content stream including at least one media content;
generating a target object try-on image according to a preset user image, preprocessed pose information of the user image, and the target object image; and
displaying a try-on interface, and presenting the target object try-on image on the try-on interface.

According to a second aspect, an embodiment of the disclosure further provides a virtual fitting apparatus. The apparatus includes:
an image obtaining module configured to obtain a target object image with which a try-on operation associates, in response to the try-on operation being received by a content browsing interface, where the content browsing interface is configured to display a media content stream including at least one media content;
a try-on image generation module configured to generate a target object try-on image according to a preset user image, preprocessed pose information of the user image, and the target object image; and
a try-on image presentation module configured to display a try-on interface, and present the target object try-on image on the try-on interface.

According to a third aspect, an embodiment of the disclosure further provides an electronic device. The electronic device includes:
one or more processors; and
a storage apparatus configured to store one or more programs, where
the one or more programs, when executed by the one or more processors, cause the one or more processors to implement the virtual fitting method described in any one of the embodiments of the disclosure.

According to a fourth aspect, an embodiment of the disclosure further provides a storage medium including computer-executable instructions, where the computer-executable instructions, when executed by a computer processor, are configured to perform the virtual fitting method described in any one of the embodiments of the disclosure.

### BRIEF DESCRIPTION OF DRAWINGS

The foregoing and other features, advantages, and aspects of embodiments of the disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a virtual fitting method according to an embodiment of the disclosure;

FIG. 2 is a flow block diagram of a live streaming scenario in a virtual fitting method according to an embodiment of the disclosure;

FIG. 3 is a schematic flowchart of a virtual fitting method according to an embodiment of the disclosure;

FIG. 4 is a flow block diagram of generating a target object try-on image in a virtual fitting method according to an embodiment of the disclosure;

FIG. 5 is a flow block diagram of obtaining a deformed object image in a virtual fitting method according to an embodiment of the disclosure;

FIG. 6 is a schematic diagram of a structure of a virtual fitting apparatus according to an embodiment of the disclosure; and

FIG. 7 is a schematic diagram of a structure of an electronic device according to an embodiment of the disclosure.

### DETAILED DESCRIPTION

The embodiments of the disclosure are described in more detail below with reference to the accompanying drawings. Although some embodiments of the disclosure are shown in the accompanying drawings, it should be understood that the disclosure may be implemented in various forms and should not be construed as being limited to the embodiments set forth herein. Rather, these embodiments are provided for a more thorough and complete understanding of the disclosure. It should be understood that the accompanying drawings and the embodiments of the disclosure are only for exemplary purposes, and are not intended to limit the scope of protection of the disclosure.

It should be understood that the various steps described in the method implementations of the disclosure may be performed in different orders, and/or performed in parallel. Furthermore, additional steps may be included and/or the execution of the illustrated steps may be omitted in the method implementations. The scope of the disclosure is not limited in this respect.

The term “include” used herein and the variations thereof are an open-ended inclusion, namely, “include but not limited to”. The term “based on” is “based at least in part on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the disclosure are only configured to distinguish different apparatuses, modules, or units, and are not configured to limit the sequence of functions performed by these apparatuses, modules, or units or interdependence.

It should be noted that the modifiers “one” and “a plurality of” mentioned in the disclosure are illustrative and not restrictive, and those skilled in the art should understand that unless the context clearly indicates otherwise, the modifiers should be understood as “one or more”.

The names of messages or information exchanged between a plurality of apparatuses in the implementations of the disclosure are used for illustrative purposes only, and are not configured to limit the scope of these messages or information.

It can be understood that the data involved in the technical solutions (including, but not limited to, the data itself and the access to or use of the data) shall comply with the requirements of corresponding laws, regulations, and relevant provisions.

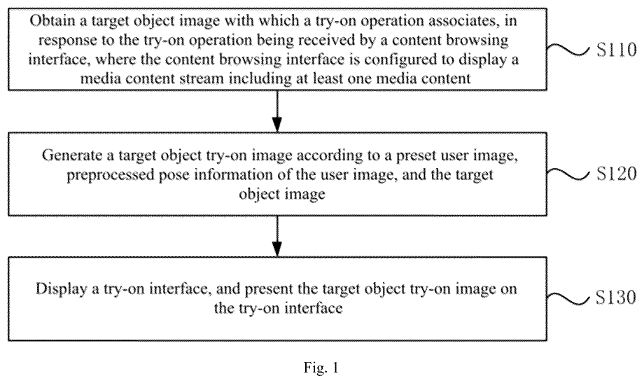

FIG. 1 is a schematic flowchart of a virtual fitting method according to an embodiment of the disclosure. The embodiment of the disclosure is applicable to a case of quick virtual fitting based on an image. The method may be performed by a virtual fitting apparatus. The apparatus may be implemented in the form of software and/or hardware, and may be configured in an electronic device, for example, may integrated in an application (APP), and installed, together with the app, in an electronic device such as a mobile phone or a computer.

As shown in FIG. 1, the virtual fitting method according to the embodiment may include the following steps.

S110: obtaining a target object image with which a try-on operation associates, in response to the try-on operation being received by a content browsing interface, where the content browsing interface is configured to display a media content stream including at least one media content.

In the embodiment of the disclosure, the virtual fitting apparatus may be integrated in an APP, which may include, for example, a content-based APP. The content-based APP may provide a content browsing interface to display a media content stream (which may be referred to as a feed stream), and the media content stream may include at least one media content. The media content may include, but is not limited to, non-real-time media content (e.g., long video, short video, images, and text) and real-time media content (e.g., live streams). When the media content is of a clothing promotion type, the content browsing interface may further be configured to receive a try-on operation for clothing associated with the media content. The target object image with which the try-on operation associates may be considered as an image of clothing that a user expects to try on.

One try-on operation may be composed of at least one trigger operation. For example, a try-on entry control may be set in a control of the content browsing interface that displays each media content, and a clothing selection interface may be entered in response to a trigger operation for the try-on entry control. Try-on controls for clothing associated with the corresponding media content may be set in the clothing selection interface. When any try-on control is triggered, a subsequent try-on process for the clothing corresponding to the try-on control may be performed. In this example, the try-on operation may include at least a trigger operation for the try-on entry control, and a trigger operation for the try-on control. In some implementations, the try-on entry control may be, for example, a clothing purchase entry control.

When the try-on control in the clothing selection interface is triggered, at least one image of the corresponding clothing may further be displayed. Accordingly, the try-on operation may further include a trigger operation of selecting a target object image from the at least one image. When receiving the try-on operation input by the user through the content browsing interface, the APP may send the try-on operation to the virtual fitting apparatus. Accordingly, the virtual fitting apparatus may obtain the target object image with which the try-on operation associates in response to the try-on operation.

S120: generating a target object try-on image according to a preset user image, preprocessed pose information of the user image, and the target object image.

In the embodiment of the disclosure, the APP integrated with the virtual fitting apparatus may allow the user to preset the user image, and may obtain the preprocessed pose information of the user image in advance.

The user image may include one user object, and may be a full-body image or a half-body image of the user object. The APP may set a plurality of user images for one user object, or may set corresponding user images for a plurality of user objects respectively.

In some optional implementations, the virtual fitting method may further include a user image presetting step, for example, may include: receiving an initial image through a fitting setting interface; and setting the initial image as the user image in response to the initial image meeting a preset setting condition.

The APP integrated with the virtual fitting apparatus may further provide the fitting setting interface in which an image upload control may be deployed. In response to triggering for the upload control, the user may upload the initial image by taking a picture or reading an image from a gallery. The preset setting condition may be preset by experience or experiments, and may include, but is not limited to, restrictions on image size, image quality, and pose and dressing type of the user object in the image. When the initial image meets the preset setting condition, it may be considered that the initial image has good suitability for virtual fitting. In this case, the initial image may be set as the user image. When the initial image does not meet the preset setting condition, it may be considered that the initial image is unsuitable for virtual fitting. In this case, the user may be prompted to reupload the initial image.

In these optional implementations, the image suitable for virtual fitting may be set as the user image by performing qualification verification on the uploaded initial image based on the preset setting condition, thereby improving the fitting effect of the virtual fitting to some extent.

In the embodiment of the disclosure, the APP may obtain preprocessed pose information of each user image in advance. For example, after setting the user image, the APP may preprocess the user image using a related interface at a local side and/or a server side, to obtain the preprocessed pose information. Accordingly, the corresponding preprocessed pose information of the user images may be stored at the local side and/or the server side, thereby accelerating subsequent virtual fitting steps. The preprocessed pose information may include information representing the pose such as the shape or posture of the user object in the user image, for example, may include, but is not limited to, a keypoint detection map, a human body detection map, and a semantic segmentation map of the user object.

In some optional implementations, the preprocessed pose information of the user image is a pose heatmap and/or a segmentation map, and the preprocessed pose information may be generated based on at least one of the following steps: extracting a pose keypoint from the user image, and determining the pose heatmap according to the pose keypoint; and performing image segmentation on the user image to obtain the segmentation map.

Keypoints of the user object in the user image may be detected based on an existing keypoint detection manner (e.g., 18-keypoint detection or 26-keypoint detection) as the pose keypoints in the user image. The determining a pose heatmap according to the pose keypoint may include: for each keypoint, displaying pixels within a certain neighborhood of the keypoint differently from pixels of other regions, for example, pixel values of pixels within an 11×11 neighborhood may be set to 1, and pixel values of pixels of other regions may be set to 0, to obtain a heatmap of a channel corresponding to the keypoint in the pose heatmap; and determining a complete pose heatmap after the heatmaps of the channels corresponding to all the keypoints are determined. The pose heatmap may be configured to represent posture information of the user object in the user image.

Each region of the user object in the user image may be semantically segmented based on an existing semantic segmentation algorithm (e.g., a residual network-based semantic segmentation algorithm, or a Transformer network-based semantic segmentation algorithm), to obtain a segmentation map. Pixels of the segmented region may be displayed differently from pixels of a background region in the segmentation map. For example, pixel values of pixels of the segmented region are set to 1, and pixel values of pixels of the background region are set to 0. The segmentation map may be configured to represent shape information of each region of the user object in the user image. In some implementations, subsequent processing (e.g., downsampling, smoothing or the like) may further be performed on the segmentation map, to adjust a shape contour of the user object, to avoid conflicts with subsequently tried-on clothing objects, which can improve the virtual fitting effect to some extent.

In these optional implementations, the posture and/or shape information of the user object in the user image may be determined by obtaining the corresponding pose heatmap and/or the segmentation map of the user image through preprocessing, which can lay the foundation for generating a target object try-on image.

Since the user usually refreshes a plurality of times in a short period of time when watching a media content stream, there is a need for quick fitting for virtual fitting in this scenario. However, virtual fitting is achieved through acquiring three-dimensional data, and modeling, which are time-consuming and cannot meet the need for quick fitting. In the embodiment of the disclosure, after obtaining the target object image, the virtual fitting apparatus may directly obtain a default user image or a user-specified user image, and obtain the preprocessed pose information of the user image. Processing such as deformation may be performed on a clothing object in the target object image according to the preprocessed pose information, so that the clothing object matches the pose of the user object in the user image. A target object try-on image may be generated according to the image information provided in the user image, and the deformed clothing object. The target object try-on image may be considered as an effect picture that the user object in the user image tries on the clothing object in the target object image, where the pose information of the user object is the same as that of the user image.

By seamlessly overlaying the clothing object on the corresponding region of the user object, a realistic try-on effect can be achieved by only changing the clothing on the user object. By presetting the user image and generating the preprocessed pose information of the user image, the target object try-on image can be quickly generated based on the target object image when the image is obtained, without the need for acquiring three-dimensional data, or modeling, thereby meeting the need for quick fitting in some scenarios.

S130: displaying a try-on interface, and presenting the target object try-on image on the try-on interface.

In the embodiment of the disclosure, the APP integrated with the virtual fitting apparatus may further provide the try-on interface that may be configured to present the target object try-on image, to show the user the try-on effect of the clothing object in the target object image.

In some optional implementations, after the presenting the target object try-on image on the try-on interface, the method may further include at least one of: adding target object information corresponding to the target object image to a preset list in response to a confirmation operation being received by the try-on interface; and returning to the content browsing interface in response to a cancel operation being received by the try-on interface.

The APP integrated with the virtual fitting apparatus may be linked to an APP with a service function of resource ownership transfer, where the resource ownership transfer may be understood as an operation of transferring an object with certain value attributes to a resource owner to obtain the ownership of the corresponding resource.

In these optional implementations, at least a confirm control and a cancel control may be deployed in the try-on interface. When the confirm control is triggered, it may be considered that a confirmation operation is received and that the user is satisfied with the try-on effect. In this case, the target object information corresponding to the target object image may be added to the preset list (e.g., a favorite list, a candidate ownership transfer list, or an ownership transfer list), to facilitate subsequent clothing ownership transfer operations. When the cancel control is triggered, it may be considered that a cancel operation is received and that the user is unsatisfied with the try-on effect. In this case, the user may return to the content browsing interface for operations such as browsing and trying on other clothing. In such a way, smooth operation and flexible and convenient interaction functions can be provided for the user after the try-on effect of the clothing object in the target object image is presented to the user.

In some implementations, the media content stream may include live streaming media content. In this case, the content browsing interface may be a live streaming interface. When the live streaming media content is in a clothing ownership transfer scenario, a try-on entry control may be set on the live streaming interface, and a clothing selection interface may be entered in response to a trigger operation for the try-on entry control, in order for the user to select clothing that the user expects to try on.

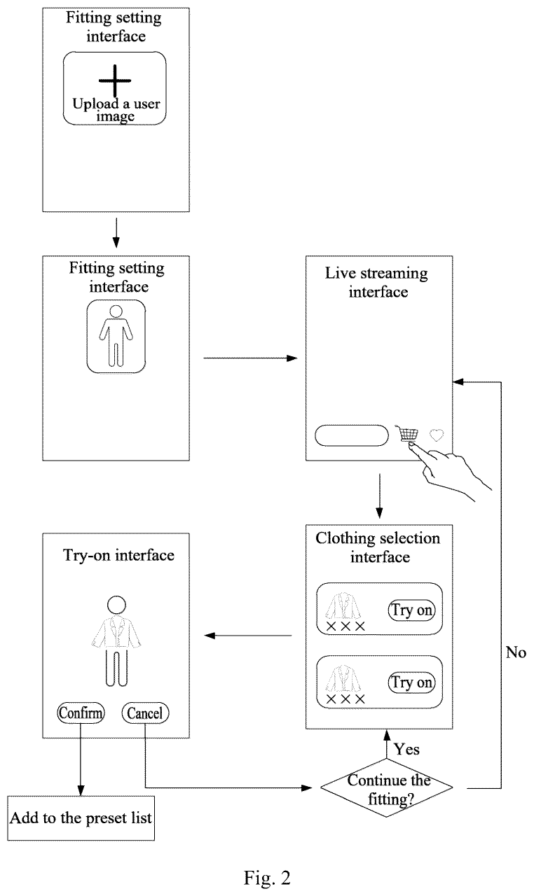

For example, FIG. 2 is a flow block diagram of a live streaming scenario in a virtual fitting method according to an embodiment of the disclosure. Referring to FIG. 2, a virtual fitting process in the live streaming scenario may include:
pre-uploading a full-body or half-body user image through the fitting setting interface of the APP, and determining the preprocessed pose information through the related interface of the local side and/or the server side;
entering the live streaming interface of the APP in the clothing ownership transfer scenario;
entering the clothing selection interface in response to triggering for the try-on entry control (e.g., a shopping cart control) in the live streaming interface;
selecting target clothing through the clothing selection interface, and selecting a target object image from at least one image corresponding to the target clothing,
obtaining a target object image with which a try-on operation associates through the virtual fitting apparatus; generating a target object try-on image according to the preset user image, preprocessed pose information of the user image, and the target object image; presenting the target object try-on image on the try-on interface,
adding, by the virtual fitting apparatus, target object information corresponding to the target object image to the preset list in response to a confirmation operation being received by the try-on interface; or returning, by the virtual fitting apparatus, to the clothing selection interface, for the user to continue the fitting, in response to a cancel operation being received by the try-on interface and when the user confirms that the fitting is continued; or returning, by the virtual fitting apparatus, to the live streaming interface, for the user to continue watching the live streaming content or other live streaming content, in response to a cancel operation being received by the try-on interface and when the user stops continuing the fitting.

In these optional implementations, the user needs to make a decision on whether to purchase the clothing in a short period of time because activities such as limited-time offers often exist during clothing ownership transfer in the live streaming scenario. By performing image-based virtual fitting through the virtual fitting method provided in the disclosure in a live streaming application, quick fitting can be achieved to provide a reference for the user to make a decision.

In the technical solutions of the embodiments of the disclosure, the target object image with which the try-on operation associates is obtained in response to the try-on operation being received by the content browsing interface, where the content browsing interface is configured to display the media content stream, and the media content stream includes the at least one media content; the target object try-on image is generated according to the preset user image, the preprocessed pose information of the user image, and the target object image; and the try-on interface is displayed, and the target object try-on image is presented on the try-on interface. By presetting the user image and generating the preprocessed pose information of the user image, the target object try-on image can be quickly generated based on the image when the target object image is obtained, which can meet the need for quick fitting in scenarios such as live streaming.

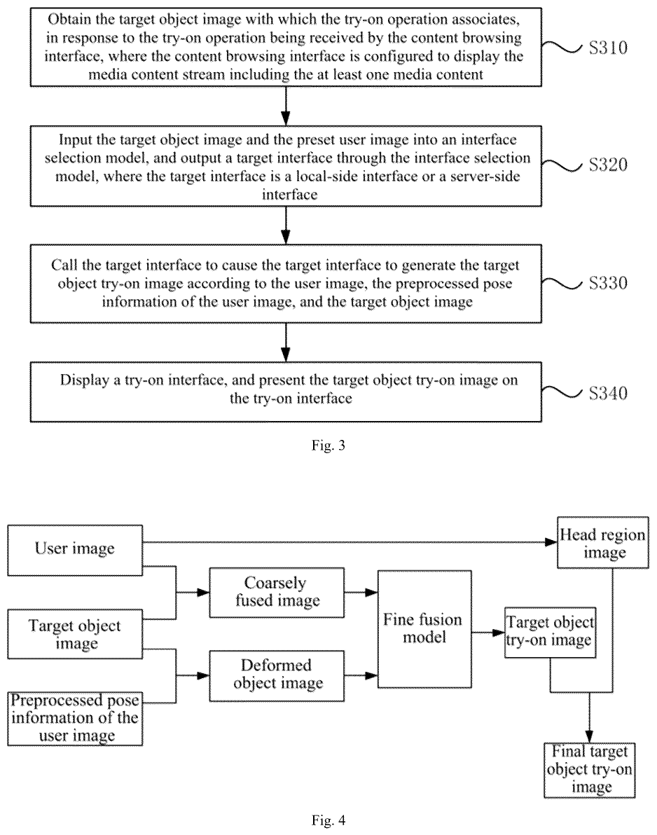

The embodiment of the disclosure may be combined with various optional solutions in the virtual fitting method provided in the above embodiments. The virtual fitting method provided in the embodiment optimizes accelerated fitting, so that the local-side interface or the server-side interface can be selected for virtual fitting according to a specific fitting situation, which can further accelerate the fitting speed. FIG. 3 is a schematic flowchart of a virtual fitting method according to an embodiment of the disclosure. As shown in FIG. 3, the virtual fitting method according to the embodiment may include the following steps.

S310: obtaining the target object image with which the try-on operation associates, in response to the try-on operation being received by the content browsing interface, where the content browsing interface is configured to display the media content stream including the at least one media content.

S320: inputting the target object image and the preset user image into an interface selection model, and outputting a target interface through the interface selection model, where the target interface is a local-side interface or a server-side interface.

In the embodiment, the local-side interface may be considered as a service function interface provided by a local side of an APP integrated with a virtual fitting apparatus and configured to generate a target object try-on image. The server-side interface may be considered as a service function interface provided by a backend server of the APP integrated with the virtual fitting apparatus and configured to generate the target object try-on image, and the server-side interface is, for example, a Hypertext Transfer Protocol (HTTP) interface.

Due to the limited resources such as computation and storage resources of the local-side interface, it may be considered that the speed of the local-side interface is significantly slower than that of the service-side interface when generating a complex target object try-on image, and the speed of the local-side interface is less different from that of the service-side interface when generating a simple target object try-on image. Therefore, when generating a complex target object try-on image, the server-side interface may be prioritized as the target interface, to accelerate the virtual fitting speed; and when generating a simple target object try-on image, the local-side interface may be prioritized as the target interface, to save time for interaction between the local side and the server side, and achieve quick fitting.

In the embodiment, supervised training may be performed on the interface selection model in advance based on a sample clothing image and a sample user image, as well as a corresponding target port annotation, and the trained interface selection model may be deployed in the APP integrated with the virtual fitting apparatus. Accordingly, based on the pre-trained interface selection model, the virtual fitting apparatus may extract local and/or global features of the target object image, and extract local and/or global features of the default or user-specified user image, to predict a target interface matching the fitting complexity, thereby achieving the quickest fitting operation.

In some further implementations, the outputting a target interface through the interface selection model may include: predicting a clothing type corresponding to the target object image through the interface selection model, and predicting at least one of the following image information of the user image: user pose classification, image clarity, and image brightness; and outputting the target interface according to the clothing type and the image information.

The clothing type corresponding to the target object image may be considered as a clothing type of the clothing object in the target object image, for example, may include, but is not limited to, jackets, base layers, skirts, pants, and the like. Different types of clothing may be considered to correspond to different degrees of difficulty in deformation. For example, it is easier to determine the effect of deformation of base layers than jackets, which is not exhaustive herein.

The user pose classification may include different levels of classification, and the corresponding pose complexity may gradually increase from low level to high level. For example, a standing pose may be considered as a lower-level user pose, and a pose of the arms crossed in front of the chest may be considered as a higher-level user pose, which is not specifically limited herein. The image clarity and image brightness of the user image may be represented respectively based on the existing image clarity index and image brightness index. In addition, the image information of the user image may further include other information (e.g., image distortion), which is not exhaustive herein.

In these optional implementations, the interface selection model may be considered as a multitasking model. The interface selection model may be configured to predict the clothing type corresponding to the target object image and at least one image information of the user image, comprehensively determine the complexity of generating the target object try-on image based on the clothing type and the image information, and output the target interface matching the complexity, thereby accelerating the generation of the target object try-on image.

In addition, the trained interface selection model may further be configured to predict image information (e.g., at least one of user pose classification, image clarity, and image brightness) of an initial image. Therefore, whether the initial image meets the preset setting condition may be determined according to the image information of the initial image, for the setting of the user image.

S330: calling the target interface to cause the target interface to generate the target object try-on image according to the user image, the preprocessed pose information of the user image, and the target object image.

In the embodiment, the user images, and the corresponding preprocessed pose information of the user images may be stored at the local side and/or the server side. The virtual fitting apparatus may call the target interface (i.e., the local-side interface, or the server-side interface), to generate the target object try-on image through the target interface. Accordingly, when a target object try-on image is generated through the server-side interface, the server-side interface can feed back the target object try-on image to the virtual fitting apparatus, so that the virtual fitting apparatus can display same.

S340: displaying a try-on interface, and presenting the target object try-on image on the try-on interface.

The technical solutions of the embodiments of the disclosure optimize accelerated fitting, so that the local-side interface or the server-side interface for virtual fitting can be selected according to a specific fitting situation, which can further accelerate the fitting speed. The virtual fitting method provided in the embodiment of the disclosure and the virtual fitting method provided in the above embodiments belong to the same concept of disclosure. For the technical details not described in detail in the embodiment, reference may be made to the above embodiments, and the same technical features have the same beneficial effects in the embodiment and the above embodiments.

The embodiment of the disclosure may be combined with various optional solutions in the virtual fitting method provided in the above embodiments. The virtual fitting method provided in the embodiment describes in detail the steps of generating a target object try-on image. First, a coarsely fused image is determined according to the target object image and the user image, then, the target object is deformed according to the preprocessed pose information, and finally, the coarsely fused image is refined based on the fine fusion model according to the deformed object image, thereby obtaining the target object try-on image with a good effect.

For example, FIG. 4 is a flow block diagram of generating a target object try-on image in a virtual fitting method according to an embodiment of the disclosure. As shown in FIG. 4, in some implementable virtual fitting methods, the generating a target object try-on image according to a preset user image, preprocessed pose information of the user image, and the target object image may include the following steps.

First, the target object image is coarsely fused with the user image to obtain the coarsely fused image.

A clothing object in the target object image may be extracted, simple processing such as scaling, rotation, and transparency adjustment may be performed on the clothing object, and the processed clothing object may be overlaid on an approximate region of the user object of the user image to obtain the coarsely fused image.

Then, the target object image is processed according to the preprocessed pose information of the user image to obtain the deformed object image. A clothing object in the deformed object image conforms to the preprocessed pose information.

Since the preprocessed pose information may represent the pose information such as the shape and posture of the user object in the user image, the clothing object in the target object image may be deformed according to the preprocessed pose information, so that the clothing object in the deformed object image can match the pose of the user object in the user image, that is, the clothing object in the deformed object image can conform to the preprocessed pose information.

Finally, the coarsely fused image and the deformed object image are input into the fine fusion model, and the target object try-on image is output through the fine fusion model.

According to related features of the clothing object in the deformed clothing, the fine fusion model may be configured to reconstruct and enhance corresponding features in a clothing object in the coarsely fused image, to obtain a realistic target object try-on image. The fine fusion model may an existing image generation model, for example, may be a neural network model with an encoder-decoder framework, and connections may skip between a network layer of the encoder and a network layer of the decoder, to achieve information sharing between different network layers, which is conducive to improving the generation of the target object try-on image.

A loss used by the fine fusion model during a training process may include: a loss determined according to a distance between a feature map corresponding to the target object try-on image output by the fine fusion model and a feature map corresponding to a real image. The loss determined during the training process according to the distance between the feature map corresponding to the target object try-on image output by the fine fusion model and the feature map corresponding to the real image may include, but is not limited to, a perceptual loss and a mean absolute error (L1) loss, which is not exhaustive herein. For example, a loss function L may be defined as a sum of the perceptual loss and the L1 loss:

$$L = {\sum }_{i = 0}^{n} {λ}_{l} {‖ {ϕ}_{i} ( {I}^{′} ) - {ϕ}_{i} ( I ) ‖}_{1} + {‖ M - {M}_{0} ‖}_{1} ;$$

where n may represent a total number of channels of the two feature maps; λᵢ∥φᵢ(I′)−φᵢ(I)∥₁ may represent the perceptual loss between the i^{th} channels of the two feature maps; and ∥M−M₀∥₁ may represent the L1 loss of the two feature maps.

By calculating the loss between the two feature maps, the generated target object try-on image may have consistent features with the real image, which can improve the generation result of the target object try-on image.

In addition, referring to FIG. 4 again, in some implementable virtual fitting methods, the method may further include: extracting a head region image from the user image, and fusing the head region image to a corresponding region of the target object try-on image to obtain a final target object try-on image. Accordingly, the presenting the target object try-on image on the try-on interface includes: presenting the final target object try-on image on the try-on interface.

In these optional implementations, a head region of the user object in the user image may further be semantically segmented according to an existing semantic segmentation algorithm, and the head region image may be extracted from the user image according to a semantic segmentation result. Since only the dressing of the user object in the target object try-on image and the user image has changed, and other regions have a positional correspondence, the extracted head region image may be directly overlaid on the corresponding position of the target object try-on image. In this way, identity information of the original user image can be injected into the target object try-on image, avoiding the deviation between a head region of the target object try-on image and the head region of the user image due to a model generation error, which can optimize the generation effect of the target object try-on image.

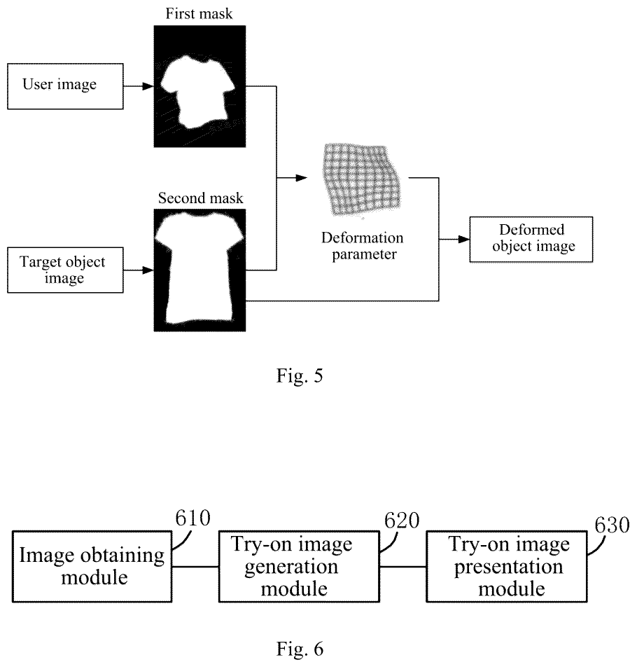

For example, FIG. 5 is a flow block diagram of obtaining a deformed object image in a virtual fitting method according to an embodiment of the disclosure. Referring to FIG. 5, in some implementable virtual fitting methods, the processing the target object image according to the preprocessed pose information of the user image to obtain the deformed object image may include the following steps.

First, a first mask of a clothing object in the user image may be determined according to the preprocessed pose information. The first mask of an original clothing object may be extracted from the user image according to the preprocessed pose information. In the first mask, pixels of the original clothing object may be set to 1, and pixels of the remaining region may be set to 0.

Then, a second mask of the clothing object in the target object image may be extracted. The second mask of the clothing object may be determined according to an existing semantic segmentation algorithm. In the second mask, pixels of the clothing object may also be set to 1, and pixels of the remaining region may be set to 0.

Then, a deformation parameter may be calculated according to the first mask and the second mask. For example, a Thin Plate Spline (TPS) of clothing deformation may be estimated by matching the shapes of the first mask and the second mask, and the TPS may be used as the deformation parameter. In addition, other existing calculation manners for the deformation parameter between masks may also be applied herein, and are not exhaustive herein.

Finally, the clothing object in the target object image is deformed according to the deformation parameter, to obtain the deformed object image. After the deformation parameter is determined, the pose and shape of the clothing object in the target object image may be deformed naturally according to the deformation parameter, so that the deformed clothing object may conform to the pose information such as the shape and posture of the user object in the user image, and detailed information of the clothing object may be fully preserved.

The technical solutions of the embodiment of the disclosure describe in detail the steps of generating a target object try-on image. First, a coarsely fused image is determined according to the target object image and the user image, then, the target object is deformed according to the preprocessed pose information, and finally, the coarsely fused image is refined based on the fine fusion model according to the deformed object image, thereby obtaining the target object try-on image with a good effect. The virtual fitting method provided in the embodiment of the disclosure and the virtual fitting method provided in the above embodiments belong to the same concept of disclosure. For the technical details not described in detail in the embodiment, reference may be made to the above embodiments, and the same technical features have the same beneficial effects in the embodiment and the above embodiments.

FIG. 6 is a schematic diagram of a structure of a virtual fitting apparatus according to an embodiment of the disclosure. The virtual fitting apparatus according to the embodiment is especially applicable to a case of quick virtual fitting based on an image.

As shown in FIG. 6, the virtual fitting apparatus according to the embodiment of the disclosure may include:
an image obtaining module 610 configured to obtain a target object image with which a try-on operation associates, in response to the try-on operation being received by a content browsing interface, where the content browsing interface is configured to display a media content stream including at least one media content;
a try-on image generation module 620 configured to generate a target object try-on image according to a preset user image, preprocessed pose information of the user image, and the target object image; and
a try-on image presentation module 630 configured to display a try-on interface, and present the target object try-on image on the try-on interface.

In some optional implementations, the virtual fitting apparatus may further include:
a user image presetting module configured to preset the user image based on the following steps:
receiving an initial image through a fitting setting interface; and
setting the initial image as the user image in response to the initial image meeting a preset setting condition.

In some optional implementations, the preprocessed pose information of the user image is a pose heatmap and/or a segmentation map, and the virtual fitting apparatus may further include:
a pose information preprocessing module configured to generate the preprocessed pose information based on at least one of the following steps:
extracting a pose keypoint from the user image, and determining the pose heatmap according to the pose keypoint; and
performing image segmentation on the user image to obtain the segmentation map.

In some optional implementations, the virtual fitting apparatus may further include:
a presentation feedback module configured to perform at least one of the following after the target object try-on image is presented on the try-on interface:
adding target object information corresponding to the target object image to a preset list in response to a confirmation operation being received by the try-on interface; and
returning to the content browsing interface in response to a cancel operation being received by the try-on interface.

In some optional implementations, the virtual fitting apparatus may further include:
a port selection module configured to input the target object image and the preset user image into an interface selection model, and output a target interface through the interface selection model after the target object image with which the try-on operation associates is received, where the target interface is a local-side interface or a server-side interface.

Accordingly, the target object try-on image generation module may be configured to:
call the target interface to cause the target interface to generate the target object try-on image according to the user image, the preprocessed pose information of the user image, and the target object image.

In some optional implementations, the port selection module may be configured to:
predict a clothing type corresponding to the target object image through the interface selection model, and predict at least one of the following image information of the user image: user pose classification, image clarity, and image brightness; and
output the target interface according to the clothing type and the image information.

In some optional implementations, the target object try-on image generation module may be configured to:
coarsely fuse the target object image with the user image to obtain a coarsely fused image;
process the target object image according to the preprocessed pose information of the user image to obtain a deformed object image, where a clothing object in the deformed object image conforms to the preprocessed pose information; and
input the coarsely fused image and the deformed object image into a fine fusion model, and output the target object try-on image through the fine fusion model.

In some optional implementations, the target object try-on image generation module may obtain the deformed object image based on the following steps:
determining a first mask of a clothing object in the user image according to the preprocessed pose information;
extracting a second mask of a clothing object in the target object image;
calculating a deformation parameter according to the first mask and the second mask; and
deforming the clothing object in the target object image according to the deformation parameter.

In some optional implementations, a loss used by the fine fusion model during a training process includes:
a loss determined according to a distance between a feature map corresponding to the target object try-on image output by the fine fusion model and a feature map corresponding to a real image.

In some optional implementations, the target object try-on image generation module may further be configured to:
extract a head region image from the user image, and fuse the head region image to a corresponding region of the target object try-on image to obtain a final target object try-on image.

Accordingly, the target object try-on image presentation module may be configured to: present the final target object try-on image on the try-on interface.

In some optional implementations, the media content stream includes media content of a live streaming application.

The virtual fitting apparatus according to the embodiment of the disclosure can perform the virtual fitting method according to any one of the embodiments of the disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not configured to limit the protection scope of the embodiments of the disclosure.

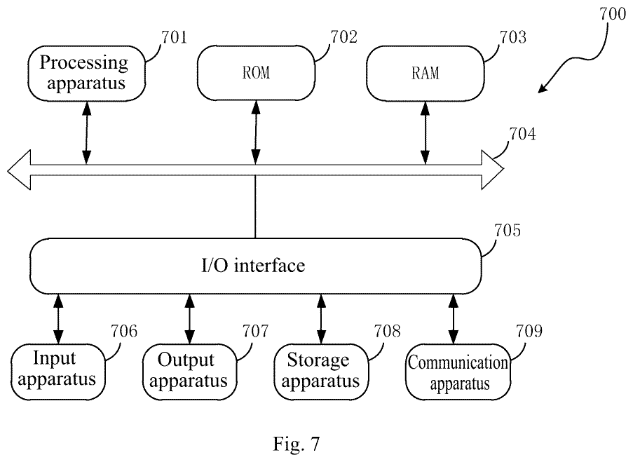

Reference is made to FIG. 7 below, which is a schematic diagram of a structure of an electronic device (such as a terminal device or a server in FIG. 7) 700 suitable for implementing embodiments of the disclosure. The terminal device in the embodiment of the disclosure may include, but is not limited to, a mobile terminal such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and a fixed terminal such as a digital TV and a desktop computer. The electronic device shown in FIG. 7 is merely an example, and shall not impose any limitation on the function and scope of use of the embodiments of the disclosure.

As shown in FIG. 7, the electronic device 700 may include a processing apparatus (e.g., a central processing unit, a graphics processing unit, etc.) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to an embodiment of the disclosure, the process described above with reference to the flowchart may be implemented as a computer software program. For example, the embodiment of the disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 709, installed from the storage apparatus 708, or installed from the ROM 702. When the computer program is executed by the processing apparatus 701, the above-mentioned functions defined in the virtual fitting method of the embodiment of the disclosure are performed.

The electronic device provided in the embodiment of the disclosure and the virtual fitting method provided in the above embodiments belong to the same concept of disclosure. For the technical details not described in detail in the embodiment, reference may be made to the above embodiments, and the embodiment and the above embodiments have the same beneficial effects.

The embodiment of the disclosure provides a computer storage medium having stored thereon a computer program that, when executed by a processor, causes the virtual fitting method provided in the above embodiments to be implemented.

It should be noted that the above computer-readable medium described in the disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electric connection with one or more wires, a portable computer disk, a hard disk, a random access memory (RAM), a read only memory (ROM), an erasable programmable read-only memory (EPROM) or a flash memory (FLASH), an optical fiber, a portable compact disc read only memory (CD-ROM), an optical storage device, a magnetic storage device, or any appropriate combination of the above. In the disclosure, the computer-readable storage medium may be any tangible medium containing or storing a program which may be used by or in combination with an instruction execution system, apparatus, or device. In the disclosure, the computer-readable signal medium may include a data signal propagated in a baseband or as apart of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device.

Alternatively, the computer-readable medium may exist independently, without being assembled into the electronic device.

The above computer-readable medium carries one or more programs that, when executed by the electronic device, cause the electronic device to:

obtain a target object image with which a try-on operation associates, in response to the try-on operation being received by a content browsing interface, where the content browsing interface is configured to display a media content stream including at least one media content; generate a target object try-on image according to a preset user image, preprocessed pose information of the user image, and the target object image; and display a try-on interface, and present the target object try-on image on the try-on interface.

Computer program code for performing operations of the disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the disclosure may be implemented by software, or may be implemented by hardware. The names of the units and the modules do not constitute a limitation on the units and the modules themselves under certain circumstances.

The functions described herein above may be performed at least partially by one or more hardware logic components. For example, without limitation, exemplary types of hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the disclosure, Example 1 provides a virtual fitting method. The method includes:
obtaining a target object image with which a try-on operation associates, in response to the try-on operation being received by a content browsing interface, where the content browsing interface is configured to display a media content stream including at least one media content;
generating a target object try-on image according to a preset user image, preprocessed pose information of the user image, and the target object image; and
displaying a try-on interface, and presenting the target object try-on image on the try-on interface.

According to one or more embodiments of the disclosure, Example 2 provides a virtual fitting method. The method further includes the following.

In some optional implementations, the method further includes:
receiving an initial image through a fitting setting interface; and
setting the initial image as the user image in response to the initial image meeting a preset setting condition.

According to one or more embodiments of the disclosure, Example 3 provides a virtual fitting method. The method further includes the following.

In some optional implementations, the preprocessed pose information of the user image is a pose heatmap and/or a segmentation map, and the preprocessed pose information is generated based on at least one of the following steps:
extracting a pose keypoint from the user image, and determining the pose heatmap according to the pose keypoint; and
performing image segmentation on the user image to obtain the segmentation map.

According to one or more embodiments of the disclosure, Example 4 provides a virtual fitting method. The method further includes the following.

In some optional implementations, after the presenting the target object try-on image on the try-on interface, the method further includes at least one of:
adding target object information corresponding to the target object image to a preset list in response to a confirmation operation being received by the try-on interface; and
returning to the content browsing interface in response to a cancel operation being received by the try-on interface.

According to one or more embodiments of the disclosure, Example 5 provides a virtual fitting method. The method further includes the following.

In some optional implementations, after the obtaining a target object image with which the try-on operation associates, the method further includes:
inputting the target object image and the preset user image into an interface selection model, and outputting a target interface through the interface selection model, where the target interface is a local-side interface or a server-side interface.

Accordingly, the generating a target object try-on image according to a preset user image, preprocessed pose information of the user image, and the target object image includes:
calling the target interface to cause the target interface to generate the target object try-on image according to the user image, the preprocessed pose information of the user image, and the target object image.

According to one or more embodiments of the disclosure, Example 6 provides a virtual fitting method. The method further includes the following.

In some optional implementations, the outputting a target interface through the interface selection model includes:
predicting a clothing type corresponding to the target object image through the interface selection model, and predicting at least one of the following image information of the user image: user pose classification, image clarity, and image brightness; and
outputting the target interface according to the clothing type and the image information.

According to one or more embodiments of the disclosure, Example 7 provides a virtual fitting method. The method further includes the following.

In some optional implementations, the generating a target object try-on image according to a preset user image, preprocessed pose information of the user image, and the target object image includes:
coarsely fusing the target object image with the user image to obtain a coarsely fused image;
processing the target object image according to the preprocessed pose information of the user image to obtain a deformed object image, where a clothing object in the deformed object image conforms to the preprocessed pose information; and
inputting the coarsely fused image and the deformed object image into a fine fusion model, and outputting the target object try-on image through the fine fusion model.

According to one or more embodiments of the disclosure, Example 8 provides a virtual fitting method. The method further includes the following.

In some optional implementations, the processing the target object image according to the preprocessed pose information of the user image includes:
determining a first mask of a clothing object in the user image according to the preprocessed pose information;
extracting a second mask of a clothing object in the target object image;
calculating a deformation parameter according to the first mask and the second mask; and
deforming the clothing object in the target object image according to the deformation parameter.

According to one or more embodiments of the disclosure, Example 9 provides a virtual fitting method. The method further includes the following.

In some optional implementations, a loss used by the fine fusion model during a training process includes:
a loss determined according to a distance between a feature map corresponding to the target object try-on image output by the fine fusion model and a feature map corresponding to a real image.

According to one or more embodiments of the disclosure, Example 10 provides a virtual fitting method. The method further includes the following.
extracting a head region image from the user image, and fusing the head region image to a corresponding region of the target object try-on image to obtain a final target object try-on image.

Accordingly, the presenting the target object try-on image on the try-on interface includes: presenting the final target object try-on image on the try-on interface.

According to one or more embodiments of the disclosure, Example 11 provides a virtual fitting method. The method further includes the following.

In some optional implementations, the media content stream includes media content of a live streaming application.

According to one or more embodiments of the disclosure, Example 12 provides a virtual fitting apparatus. The apparatus includes:
an image obtaining module configured to obtain a target object image with which a try-on operation associates, in response to the try-on operation being received by a content browsing interface, where the content browsing interface is configured to display a media content stream including at least one media content;
a try-on image generation module configured to generate a target object try-on image according to a preset user image, preprocessed pose information of the user image, and the target object image; and
a try-on image presentation module configured to display a try-on interface, and present the target object try-on image on the try-on interface.

The foregoing descriptions are merely preferred embodiments of the disclosure and explanations of the applied technical principles. Those skilled in the art should understand that the scope of disclosure involved in the disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the disclosure (but not limited thereto) also falls within the scope of the disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method for virtual fitting, comprising:
obtaining a target object image with which a try-on operation associates, in response to the try-on operation being received by a content browsing interface, wherein the content browsing interface is configured to display a media content stream comprising at least one media content;
generating a target object try-on image according to a preset user image, preprocessed pose information of the user image, and the target object image; and
displaying a try-on interface, and presenting the target object try-on image on the try-on interface.

2. The method of claim 1, further comprising:
receiving an initial image through a fitting setting interface; and
setting the initial image as the user image in response to the initial image meeting a preset setting condition.

3. The method of claim 1, wherein the preprocessed pose information of the user image comprises a pose heatmap and/or a segmentation map, and
generating the preprocessed pose information comprises at least one of:
extracting a pose keypoint from the user image, and determining the pose heatmap according to the pose keypoint;
performing image segmentation on the user image to obtain the segmentation map.

4. The method of claim 1, wherein after the presenting the target object try-on image on the try-on interface, the method further comprises at least one of:
adding target object information corresponding to the target object image to a preset list in response to a confirmation operation being received by the try-on interface; and
returning to the content browsing interface in response to a cancel operation being received by the try-on interface.

5. The method of claim 1, wherein after the obtaining a target object image with which a try-on operation associates, the method further comprises:
inputting the target object image and the preset user image into an interface selection model, and outputting a target interface through the interface selection model, wherein the target interface is a local-side interface or a server-side interface; and
the generating a target object try-on image according to a preset user image, preprocessed pose information of the user image, and the target object image comprises:
calling the target interface to cause the target interface to generate the target object try-on image based on the user image, the preprocessed pose information of the user image, and the target object image.

6. The method of claim 5, wherein the outputting a target interface through the interface selection model comprises:
predicting a clothing type corresponding to the target object image through the interface selection model;
predicting image information of the user image, wherein the image information comprises at least one of user pose classification, image clarity, and image brightness; and
outputting the target interface according to the clothing type and the image information.

7. The method of claim 1, wherein the generating a target object try-on image according to a preset user image, preprocessed pose information of the user image, and the target object image comprises:
coarsely fusing the target object image with the user image to obtain a coarsely fused image;
processing the target object image according to the preprocessed pose information of the user image to obtain a deformed object image, wherein a clothing object in the deformed object image conforms to the preprocessed pose information; and
inputting the coarsely fused image and the deformed object image into a fine fusion model, and outputting the target object try-on image through the fine fusion model.

8. The method of claim 7, wherein the processing the target object image according to the preprocessed pose information of the user image comprises:
determining a first mask of a clothing object in the user image according to the preprocessed pose information;
extracting a second mask of a clothing object in the target object image;
calculating a deformation parameter according to the first mask and the second mask; and
deforming the clothing object in the target object image according to the deformation parameter.

9. The method of claim 7, wherein a loss used by the fine fusion model during a training process comprises:
a loss determined according to a distance between a feature map corresponding to the target object try-on image output by the fine fusion model and a feature map corresponding to a real image.

10. The method of claim 1, further comprising:
extracting a head region image from the user image, and fusing the head region image to a corresponding region of the target object try-on image to obtain a final target object try-on image; and
the presenting the target object try-on image on the try-on interface comprises: presenting the final target object try-on image on the try-on interface.

11. The method of claim 1, wherein the media content stream comprises live streaming media content.

12. An apparatus for virtual fitting, comprising:
at least a processor, and
a non-transitory memory with instructions thereon,
wherein the instructions upon execution by the processor, cause the processor to:
obtain a target object image with which a try-on operation associates, in response to the try-on operation being received by a content browsing interface, wherein the content browsing interface is configured to display a media content stream comprising at least one media content;
generate a target object try-on image according to a preset user image, preprocessed pose information of the user image, and the target object image; and
display a try-on interface, and present the target object try-on image on the try-on interface.

13-14. (canceled)

15. The apparatus of claim 12, wherein the instructions upon execution by the processor, further cause the processor to:
receive an initial image through a fitting setting interface; and
set the initial image as the user image in response to the initial image meeting a preset setting condition.

16. The apparatus of claim 12, wherein the preprocessed pose information of the user image comprises a pose heatmap and/or a segmentation map, and
wherein the instructions upon execution by the processor, further cause the processor to:
extract a pose keypoint from the user image, and determine the pose heatmap according to the pose keypoint; and/or
perform image segmentation on the user image to obtain the segmentation map.

17. The apparatus of claim 12, wherein after the presenting the target object try-on image on the try-on interface, the instructions upon execution by the processor, further cause the processor to:
adding target object information corresponding to the target object image to a preset list in response to a confirmation operation being received by the try-on interface; and/or
returning to the content browsing interface in response to a cancel operation being received by the try-on interface.

18. The apparatus of claim 12, wherein after the obtaining a target object image with which a try-on operation associates, the instructions upon execution by the processor, further cause the processor to:
input the target object image and the preset user image into an interface selection model, and output a target interface through the interface selection model, wherein the target interface is a local-side interface or a server-side interface; and
wherein the instructions upon execution by the processor, further cause the processor to:
call the target interface to cause the target interface to generate the target object try-on image based on the user image, the preprocessed pose information of the user image, and the target object image.

19. The apparatus of claim 18, wherein the instructions upon execution by the processor, further cause the processor to:
predict a clothing type corresponding to the target object image through the interface selection model;
predict image information of the user image, wherein the image information comprises at least one of user pose classification, image clarity, and image brightness; and
output the target interface according to the clothing type and the image information.

20. The apparatus of claim 12, wherein the instructions upon execution by the processor, further cause the processor to:
coarsely fuse the target object image with the user image to obtain a coarsely fused image;
process the target object image according to the preprocessed pose information of the user image to obtain a deformed object image, wherein a clothing object in the deformed object image conforms to the preprocessed pose information; and
input the coarsely fused image and the deformed object image into a fine fusion model, and output the target object try-on image through the fine fusion model.

21. The apparatus of claim 20, wherein the instructions upon execution by the processor, further cause the processor to:
determine a first mask of a clothing object in the user image according to the preprocessed pose information;
extract a second mask of a clothing object in the target object image;
calculate a deformation parameter according to the first mask and the second mask; and
deform the clothing object in the target object image according to the deformation parameter.

22. A non-transitory computer-readable storage medium storing instructions that cause at least a processor to:
obtain a target object image with which a try-on operation associates, in response to the try-on operation being received by a content browsing interface, wherein the content browsing interface is configured to display a media content stream comprising at least one media content;
generate a target object try-on image according to a preset user image, preprocessed pose information of the user image, and the target object image; and
display a try-on interface, and present the target object try-on image on the try-on interface.
